(19) United States
(12) Patent Application Publication
(10) Pub. No.: US 2008/0133792 A1
(43) Pub. Date: Jun. 5, 2008

(54) Information processing device, method and program for displaying number of transferred data

(75) Inventors: Kenji Yamaguchi, Osaka (JP); Yasutaro Miyake, Osaka (JP); Noriko Shikata, Osaka (JP)

Correspondence Address: KRATZ, QUINTOS & HANSON, LLP, 1420 K Street, N.W., Suite 400, WASHINGTON, DC, 20005, US

(73) Assignee: SANYO ELECTRIC CO., LTD., Moriguchi-shi (JP)

(21) Appl. No.: 11/976,242

(22) Filed: Oct. 23, 2007

(30) Foreign Application Priority Data
Oct. 26, 2006 (JP) 2006-291670

(51) Int. Cl. G06F 13/18

(52) U.S. Cl. 710/34

(57) ABSTRACT

An information processing device for reducing the time required for the data transfer as much as possible while displaying information of the data transfer state in synchronization with the data transfer. The information processing device is equipped with a counter for counting the number of pieces of data having been transferred in a data transfer. When a large number of pieces of data is to be transferred in the data transfer, the number of pieces of data having been transferred is displayed every time a certain number of pieces of data, not one piece of data, are transferred.

### BACKGROUND OF THE INVENTION

(1) Field of the Invention

The present invention relates to an information processing device, and especially to displaying the number of transferred data during a data backup.

(2) Description of the Related Art

Data may be transferred from, for example, the address book of a mobile telephone to an external memory such as a microSD™ card to take the backup of the data. In such backup of data, it is preferable that the data transfer is completed in a short time period.

There is a mobile telephone having a function to display the number of data having been transferred on the monitor thereof, during a data transfer performed to take the backup of a plurality of pieces of data. According to the technology, each time one piece of data is transferred, “1” is added to the number of data having been transferred so far, and the number as a result of the addition is displayed. For example, when the backup of the address book is being taken, the number of data having been transferred so far among the personal data registered with the address book is displayed on the monitor of the mobile telephone.

According to this technology, displaying the number of transferred data is synchronized with transferring data. That is to say, each time one piece of data is transferred, “1” is added to the number of data having been transferred so far, and the number after the addition is displayed. The software for controlling the data transfer instructs the hardware such as a graphic engine to display one piece of data, receives a display completion notification or the like for the piece of data from the hardware, and then instructs the hardware to transfer the next piece of data. Such a structure has a problem that the data transfer as a whole is delayed when the display process or the like takes a lot of time. This is because a transfer of the next piece of data cannot be performed until a display completion notification for the current piece of data is received.

One may consider that the next piece of data may be started to be transferred before the display completion notification for the current piece of data is received, and a display request may be output each time a transfer of one piece of data is completed. However, with such a structure, when a plurality of display requests are output consecutively for each data transfer, the process of displaying the screen by the graphic engine cannot keep up with the requests. And as a result, the display of the number of transferred data may be omitted, with regard to some of the data. In that case, the number of transferred data being displayed does not match the number of data having been transferred actually.

### SUMMARY OF THE INVENTION

The present invention is an information processing device for updating display of the number of pieces of data having been transferred during execution of transferring a plurality of pieces of data, the information processing device comprising: a transfer unit operable to perform a data transfer between a first storage medium provided in the own device and a second storage medium connected to the own device; and a display control unit operable to cause a display device to display the number of pieces of data having been transferred such that the number of times the display is updated is smaller than the number of the plurality of pieces of data.

Also, the present invention is a method of displaying the number of pieces of data having been transferred, for use in an information processing device for updating display of the number of pieces of data having been transferred during execution of transferring a plurality of pieces of data, the method comprising the steps of: performing a data transfer between a first storage medium provided in the information processing device and a second storage medium connected to the information processing device; and causing a display device to display the number of pieces of data having been transferred such that the number of times the display is updated is smaller than the number of the plurality of pieces of data.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing the functional structure of a mobile telephone 100 of the present invention;

FIG. 2 shows appearances of the mobile telephone 100 and the memory card 200;

FIG. 3 shows a conventional transition of a display screen indicating the data transfer state;

FIG. 4 shows examples of display screens of the present invention where the number of data having been transferred is displayed during data transfer;

FIG. 5 is a sequence diagram showing a sequence of operations performed by the control unit, GE, and LCD of the present invention;

FIG. 6 is a flowchart showing the operation of the control unit 170 in a data transfer of the present invention; and

FIG. 7 is a sequence diagram showing a sequence of operations performed by the control unit, GE, and LCD of the conventional technology.

### DESCRIPTION OF THE PREFERRED EMBODIMENT

### Embodiment

The following describes a mobile telephone as a preferred embodiment of the information processing device of the present invention, with reference to the attached drawings.

### <Structure>

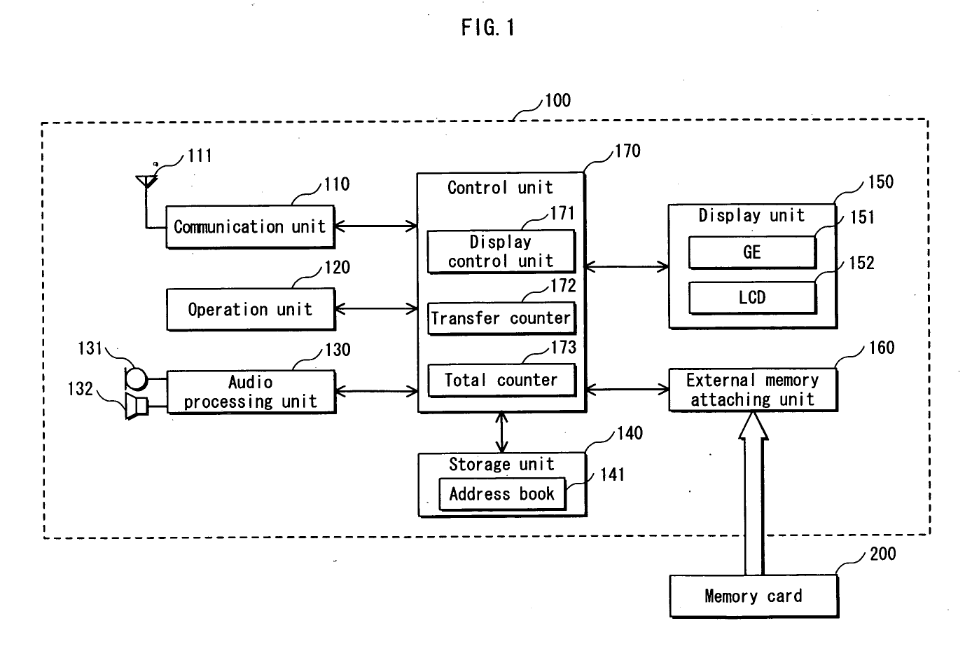

FIG. 1 is a block diagram showing the functional structure of a mobile telephone 100 of the present invention. As shown FIG. 1, the mobile telephone 100 includes a communication unit 110, an operation unit 120, an audio processing unit 130, a storage unit 140, a display unit 150, an external memory attaching unit 160, and a control unit 170. Also, a memory card 200 is attached to the mobile telephone 100.

The above-mentioned transfer unit is achieved by the control unit 170. Also, the first storage medium corresponds to the storage unit 140, and the second storage medium corresponds to the memory card 200. The display device is achieved by the display unit 150, and the display control unit is achieved by the control unit 170.

The communication unit 110 is equipped with an antenna 111. The communication unit 110 has a function to demodulate a reception signal received from the antenna 111 into a reception audio signal and a reception data signal, output the demodulated reception audio signal to the audio processing unit 130, and output the demodulated reception data signal to the control unit 170. The communication unit 110 also has a function to modulate a transmission audio signal having been subjected into an A/D conversion performed by the audio processing unit 130, modulate a transmission data signal such as an electronic mail sent from the control unit 170, and output the modulated signals from the antenna 111.

The operation unit 120 includes a numeric keypad, an on-hook key, an off-hook key, a direction key, a decision key, and a mail key, and has a function to receive an operations made by the user, and convey the content of the received operation to the control unit 170. Especially, in the present invention, the operation unit 120 receives an instruction regarding a data transfer from the user.

The audio processing unit 130 has a function to perform a D/A conversion onto a reception audio signal output from the communication unit 110 and output the converted signal to a speaker 132, and has a function to perform an A/D conversion onto a transmission audio signal obtained from a microphone 131 and output the converted signal to the communication unit 110.

The storage unit 140 includes a ROM (Read Only Memory) and a RAM (Random Access Memory), and is achieved by, for example, a small-scale hard disk or a nonvolatile memory. Especially, in the present invention, the storage unit 140 stores an address book 141 in which contact information of family members, friends and the like of the user of the mobile telephone 100 are recorded for each of persons and industries.

Here, the address book 141 will be described in detail. Each piece of information recorded in the address book 141 at least includes a telephone number or a mail address, as well as the name of a contact destination which is used by the user. And one piece of data regarding a contact destination is recorded as one piece of address data. The address data may include an address of a residence. As another example, the address data may include a birthday of a person when the contact destination is the person. The address book 141 is a collection of these address data. In the storage unit 140, each piece of address data is recorded in a unified format, having the same amount. Accordingly, the address data is stored in the storage unit 140 in order in a unit of a predetermined address value. When the backup of the address book 141 is taken, a data transfer is executed in units of address data. Also, number “1” is added to the number of transferred data when one piece of address data is transferred.

The display unit 150 includes a GE (Graphic Engine) 151 and an LCD (Liquid Crystal Display) 152. The GE 151 has a function to generate pixel data of an image to be displayed on the LCD 152 based on the instruction of the application program executed by the control unit 170, and output a display command for causing the LCD 152 to display the image. The LCD 152 has a function to display the image using the pixel data generated by the GE 151. The LCD 152 also has a function to output a display completion command to the GE 151, the command indicating that the display has been executed. Upon receiving the display completion command, the GE 151 outputs a display completion answer to a display control unit 171 of the control unit 170, in response to a display request.

The external memory attaching unit 160 is a slot into which the memory card 200 is attached. The external memory attaching unit 160 has a function to transfer data between the memory card 200 and the storage unit 140, according to an instruction from the control unit 170.

The control unit 170 has a function to control the units constituting the mobile telephone 100. Especially, the control unit 170 has a function to execute a data transfer between the storage unit 140 and the memory card 200 attached to the external memory attaching unit 160. In the present embodiment, it is presumed that data contained in the address book 141 stored in the storage unit 140 is transferred to the memory card 200.

The control unit 170 includes a display control unit 171, a transfer counter 172, and a total counter 173.

The display control unit 171 has the following functions to perform when a data transfer between the storage unit 140 and the memory card 200 attached to the external memory attaching unit 160 is performed. Basically, the display control unit 171 outputs a display request to the GE 151 after a data transfer of one piece of data is executed, the display request being a request for displaying information indicating that a data transfer has been executed. And the display control unit 171 causes the data transfer to wait until a display answer is returned, the display answer indicating that the display has been executed. When the number of data to be transferred in one data transfer is 101 or more, the display control unit 171 outputs a display request for displaying the number of transferred data to the GE 151 every time 10 pieces of data, not one piece of data, are transferred. For example, when data is transferred from the address book 141 registering 189 addresses, the display control unit 171 outputs the display request every time 10 pieces of data are transferred.

When the number of data to be transferred in one data transfer is 101 or more, the transfer counter 172 counts a data transfer every time 10 pieces of data are transferred. More specifically, starting with “0”, the transfer counter 172 adds “1” to the counter each time one piece of data is transferred, and when 10 pieces of data have been transferred, the transfer counter 172 notifies it to the display control unit 171, and resets the counter to “0”.

The total counter 173 has a function to count the number of data that have been transferred in total, and notify the counted number to the display control unit 171.

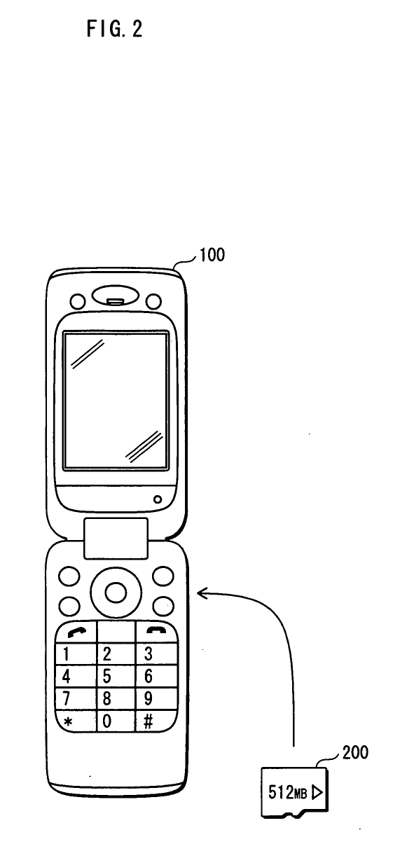

FIG. 2 shows an appearance of the mobile telephone 100. As shown in FIG. 2, the memory card 200 can be attached to the mobile telephone 100. The memory card 200 is, for example, microSD™ card.

### <Data>

Here, a display example indicating a data transfer state in a data transfer is presented.

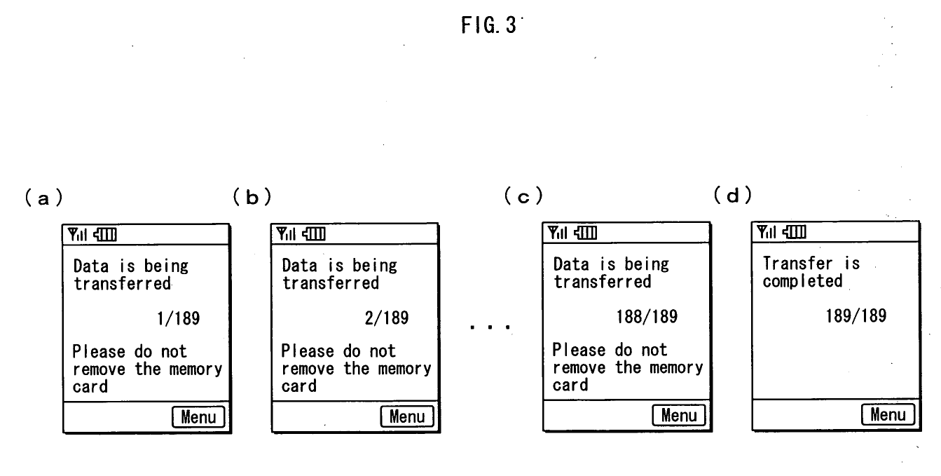

FIG. 3 shows a conventional transition of a display screen indicating the data transfer state. It should be noted here that, even in the present invention, when the number of data to be transferred in one data transfer is 100 or less, the display screen is displayed in the same manner as the conventional display screen. FIG. 3 indicates that a display request is output from the control unit 170 to the display unit 150 every time one piece of data is transferred, and the contents as shown in FIG. 3 are displayed on the LCD 152 in the order from (a) to (d).

The (a) of FIG. 3 is an example of a display screen indicating that a transfer of the first piece of data has been completed. In this display screen, the sign “ 1/189” indicates that the first piece of data among 189 pieces of data to be transferred in total has been transferred.

The (b) of FIG. 3 is an example of a display screen indicating that a transfer of up to the second piece of data has been completed. The (c) of FIG. 3 is an example of a display screen indicating that a transfer of up to the 188^{th} piece of data has been completed. And the (d) of FIG. 3 is an example of a display screen indicating that a transfer of 189 pieces of data has been completed.

A message “Please do not remove the memory card” is shown in each of the display screens (a) to (c) of FIG. 3 while the data transfer is performed. The message is not shown in display screen (d) of FIG. 3 when the data transfer has been completed.

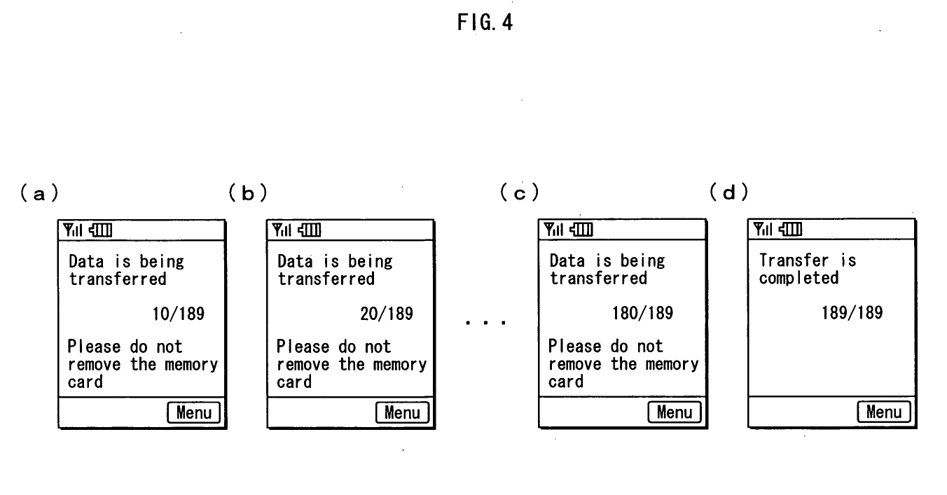

As understood from this, conventionally, the display of the number of transferred data is updated each time a data transfer of one piece of data is completed. In contrast to this, FIG. 4 shows an example of the display screen of the present invention when the number of data to be transferred in one data transfer is 101 or more.

The (a) of FIG. 4 is an example of a display screen indicating that a transfer of up to the 10^{th} piece of data has been completed. In this display screen, the sign “ 10/189” indicates that 10 pieces of data among 189 pieces of data to be transferred in total have been transferred.

The (b) of FIG. 4 is an example of a display screen indicating that a transfer of up to the 20^{th} piece of data has been completed. The (c) of FIG. 4 is an example of a display screen indicating that a transfer of up to the 180^{th} piece of data has been completed. And the (d) of FIG. 4 is an example of a display screen indicating that a transfer of 189 pieces of data has been completed.

A message “Please do not remove the memory card” is shown in each of the display screens (a) to (c) of FIG. 4 while the data transfer is performed. The message is not shown in display screen (d) of FIG. 4 when the data transfer has been completed.

As shown in FIG. 4, in the case of the present invention, the display of the number of transferred data is updated each time a data transfer of 10 pieces of data is completed. Also, when the whole data transfer is completed, the display is updated as shown in (d) of FIG. 4 regardless of whether a data transfer of 10 pieces of data is completed since the preceding display.

### <Operation>

Here will be described how the display output in a data transfer is executed among the control unit 170, the GE 151, and the LCD 152, in relation to the operation in the present embodiment.

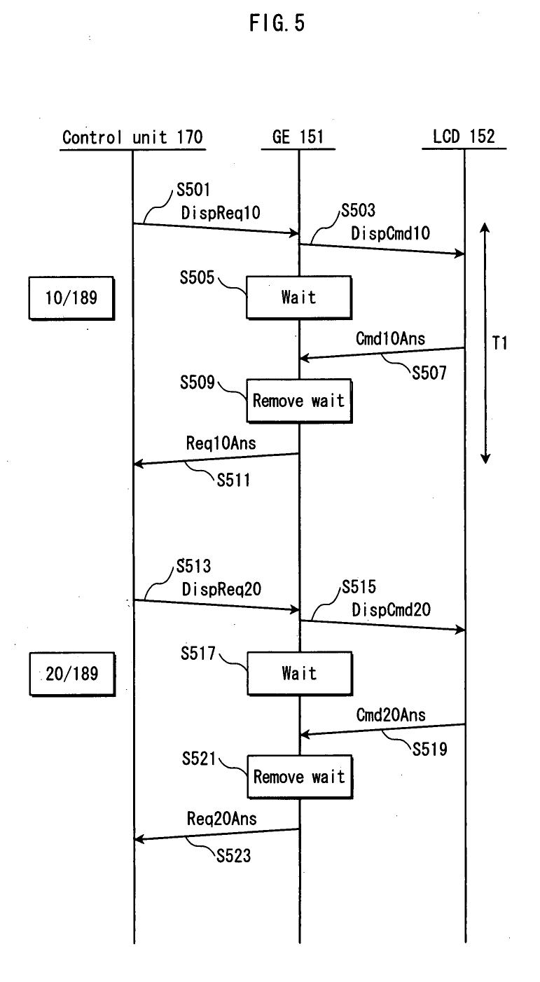

FIG. 5 is a sequence diagram showing a sequence of displays of transfer state during execution of a data transfer by the present invention. In this example of the operation, it is presumed that data is transferred to the memory card 200 from the address book 141 that registers 189 pieces of address data.

First, the control unit 170 writes data one by one in order from the address book 141 to the memory card 200 via the external memory attaching unit 160. When it has written the 10^{th} piece of data, the control unit 170 outputs, to the GE 151, a display request DispReq10 requesting to display information indicating that a transfer of 10 pieces of data has been completed (step S501).

Upon receiving the display request DispReq10, the GE 151 generates pixel data of an image to be displayed, and outputs a display command DispCmd10 for causing the LCD 152 to display the image using the generated pixel data (step S502). The GE 151 enters and is in a wait state until it receives, from the LCD 152, a display completion command indicating that the LCD 152 has completed the display (step S505). The GE 151 in the wait state does not receive the next display request.

Upon receiving the display request, the LCD 152 displays “ 10/189” indicating the number of data having been transferred. And the LCD 152 returns, to the GE 151, a display completion command Cmd10Ans indicating that the display has been completed (step S507).

Upon receiving Cmd10Ans, the GE 151 removes the wait state (step S509), and outputs a display completion answer Req10Ans to the control unit 170, the Req10Ans indicating that the display based on DispReq10 has been completed (step S511). Upon receiving the display completion answer Req10Ans, the control unit 170 executes a data transfer of the 11^{th} piece of data.

Following this, the control unit 170 continues to execute the data transfer of the 12^{th}, the 13^{th} piece of data and so on. Then, after transferring the 20^{th} piece of data, the control unit 170 outputs, to the GE 151, a display request DispReq20 requesting to display information indicating that a transfer of 20 pieces of data has been completed (step S513).

Upon receiving the display request DispReq20, the GE 151 generates pixel data of an image to be displayed, and outputs a display command DispCmd20 for causing the LCD 152 to display the image using the generated pixel data (step S515). The GE 151 enters and is in a wait state until it receives, from the LCD 152, a display completion command indicating that the LCD 152 has completed the display (step S517).

Upon receiving the display request, the LCD 152 displays “ 20/189” indicating the number of data having been transferred. And the LCD 152 returns, to the GE 151, a display completion command Cmd20Ans indicating that the display has been completed (step S519).

Upon receiving Cmd20Ans, the GE 151 removes the wait state (step S521), and outputs a display completion answer Req20Ans to the control unit 170, the Req20Ans indicating that the display based on DispReq20 has been completed (step S523). Upon receiving the display completion answer Req20Ans, the control unit 170 executes a data transfer of the 21^{st} piece of data.

Following the procedures described above, the mobile telephone 100 executes the display of the information regarding data having been transferred in a data transfer.

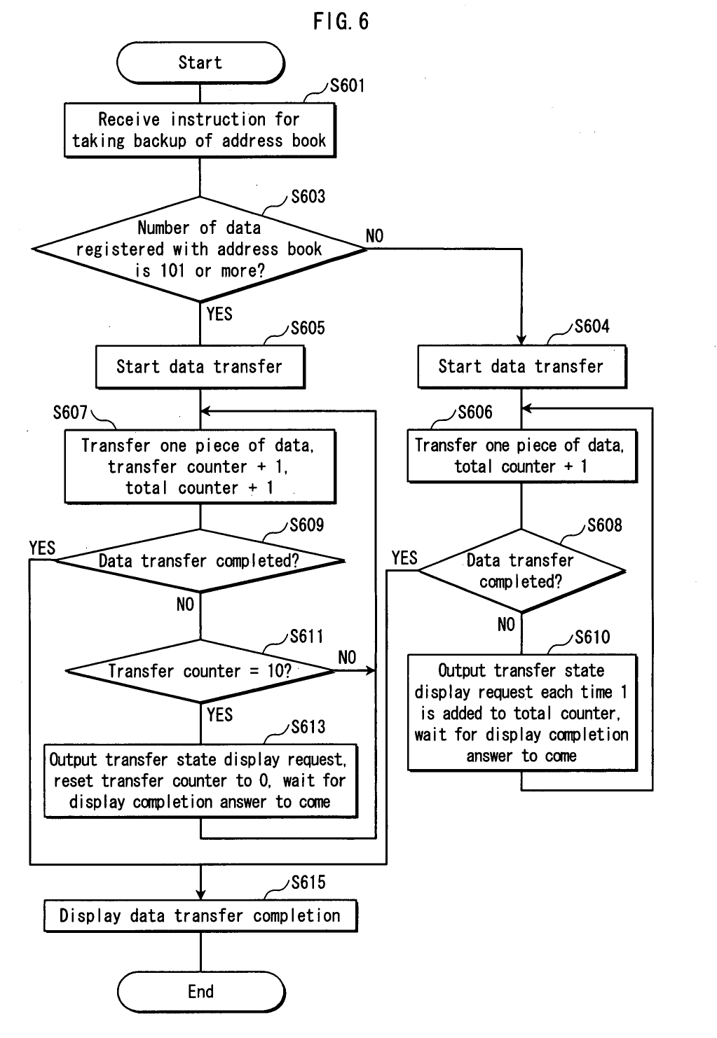

FIG. 6 is a flowchart showing the operation of the control unit 170 in displaying the data transfer state in a data transfer of the present invention.

First, the mobile telephone 100 receives a data transfer instruction via the operation unit 120 (step S601). It is presumed here that the mobile telephone 100 receives a transfer instruction for a data backup from the storage unit 140 of the address book 141 to the memory card 200. Upon receiving the instruction, the control unit 170 detects the number of pieces of address data registered with the address book 141, and judges whether or not the detected number is 101 or more (step S603). In this process, the control unit 170 stores the total number of data to be transferred.

When 101 or more pieces of address data are registered with the address book 141 (YES in step S603), the control unit 170 starts the data transfer and causes the transfer counter 172 and the total counter 173 to start counting (step S605). Each time a transfer of one piece of address data is executed, the transfer counter 172 and the total counter 173 add “1” to the counted number (step S607). As described earlier, each piece of address data has a predetermined amount. Therefore, the addresses are separated in a predetermined unit that corresponds to the predetermined amount of address data, starting with the address of the address book 141, and data at each separated address is transferred.

At this point in time, the control unit 170 judges whether a transfer of all data has been completed, by judging whether the number counted by the total counter 173 matches the stored number being the number of data to be transferred (step S609). When the transfer of all data has not been completed (NO in step S609), the transfer counter 172 judges whether or not the number counted by the transfer counter 172 has reached “10” (step S611).

When the counted number has reached “10” (YES in step S611), the transfer counter 172 notifies the fact to the display control unit 171. Upon receiving the notification, the display control unit 171 suspends the data transfer operation. The display control unit 171 outputs, to the GE 151, a display request for displaying the number of counts held by the total counter 173 currently, and the transfer counter 172 resets the number of counts to “0”, triggered by the number of counts having reached “10”. And the display control unit 171 waits for a display completion answer to come from the GE 151 (step S613).

Upon receiving the display request, the GE 151 generates pixel data of an image to be displayed, based on the received number being the number of transferred data, namely the number of counts of the total counter, and outputs a display command for causing the LCD 152 to display the image using the generated pixel data. After displaying, the LCD 152 outputs a display completion command indicating that it has completed the display. Upon receiving the display completion command, the GE 151 returns a display completion answer to the control unit 170. Upon receiving the display completion answer, the display control unit 171 of the control unit 170 removes the restriction on the data transfer.

The control unit 170 returns to step S607 and continues to execute the process onwards.

When it is judged that the transfer of all data has been completed, namely, when the number counted by the total counter 173 matches the stored number being the number of data to be transferred (YES in step S609), the control unit 170 causes the display unit 150 to display information as shown in (d) of FIG. 4 indicating that a data transfer has been completed (step S615), and ends the data transfer process.

When it is judged that the number of pieces of address data registered with the address book 141 is not more than 101 (NO in step S603), the control unit 170 starts the data transfer and causes the total counter 173 to start counting (step S604). Each time a transfer of one piece of address data is executed, the total counter 173 add “1” to the counted number (step S606).

The control unit 170 then judges whether a transfer of all data has been completed, by judging whether the number counted by the total counter 173 matches the stored number being the number of data to be transferred (step S608).

When the transfer of all data has not been completed (NO in step S608), the total counter 173 notifies the display control unit 171 of the fact that “1” has been added to the counted number. Upon receiving the notification, the display control unit 171 suspends the data transfer operation. The display control unit 171 outputs, to the GE 151, a display request for displaying the number of counts held by the total counter 173 currently, and waits for a display completion answer to come from the GE 151 (step S610).

Upon receiving the display request, the GE 151 generates pixel data of an image to be displayed, based on the received number being the number of transferred data, namely the number of counts of the total counter, and outputs a display command for causing the LCD 152 to display the image using the generated pixel data. The LCD 152 outputs a display completion command indicating that it has completed the display. Upon receiving the display completion command, the GE 151 returns a display completion answer to the control unit 170. Upon receiving the display completion answer, the display control unit 171 of the control unit 170 removes the restriction on the data transfer.

The control unit 170 returns to step S606 and continues to execute the process onwards.

When it is judged in step S608 that the transfer of all data has been completed, namely, when the number counted by the total counter 173 matches the stored number being the number of data to be transferred (YES in step S608), the control unit 170 causes the display unit 150 to display information as shown in (d) of FIG. 3 indicating that a data transfer has been completed (step S615), and ends the data transfer process.

As described up to now, the present invention is applicable to in a mobile telephone having a basic specification in which, when the user instructs the mobile telephone to transfer a plurality of pieces of data, the mobile telephone executes the data transfer one piece by one piece, updating the number of transferred data, and transfers the next piece of data after updating the display of the number of transferred data. The present invention enables a mobile telephone with such a specification to display the number of transferred data indicating the transfer state, a smaller number of times than the total number of pieces of data to be transferred, when the total number of pieces of data to be transferred is large. With this structure, there is no need to display the number of data having been transferred so far each time a piece of data is transferred, thus reducing the number of times the display of the number of transferred data is updated. The structure also reduces the number of times the notification of the display completion is awaited, and reduces the number of processes performed in the data transfer, thus resulting in a reduction of a time required for the data transfer.

### <Supplementary Notes>

Up to now, a mobile telephone of the present invention has been explained through an embodiment. However, the present invention is not limited to the embodiment, but can be achieved in various ways. The following are examples of such modifications.

(1) The present invention may be a method of displaying transfer information when a data transfer is executed by an information processing device such as the mobile telephone of the above-described embodiment. Also, the present invention may be a program for causing a computer of the information processing device to execute the display method.

(2) In the above-described embodiment, when the number of data to be transferred is 101 or more, the transfer information is displayed every time 10 pieces of data are transferred. This may be performed when the number of data to be transferred is, for example, 200. Also, when the number of data to be transferred is less than 101, the transfer information may be displayed every time 10 pieces of data are transferred.

(3) Provided in the above-described embodiment is an example of operation when data stored in the address book is transferred. However, since the essential point of the present invention is in the manner in which the transfer state information is displayed when a data transfer is executed by an information processing device such as a mobile telephone, the data to be transferred may be other than those stored in the address book. The data for the data transfer may be, for example, image data, text data, and/or movie data.

(4) In the above-described embodiment, a data transfer from the storage unit 140 to the memory card 200 is described as an example. Not limited to this, the data may be transferred in reverse direction, namely, from the memory card 200 to the storage unit 140. In that case, the number of pieces of data having been transferred from the memory card 200 to the storage unit 140 is displayed each time a predetermined number of data is transferred.

(5) In the above-described embodiment, when the number of data to be transferred exceeds 100, the data transfer state information is displayed each time 10 pieces of data are transferred. However, not limited to 10 pieces of data, the data transfer state information may be displayed each time, for example, 5 pieces of data are transferred or 20 pieces of data are transferred.

Furthermore, the following modification is available. That is to say, the unit of transferred data in which the data transfer state information is displayed may be changed in accordance with the number of data having been transferred so far. For example, in the first stage, the data transfer state information is displayed every time one piece of data is transferred, then in the next stage, when the number of transferred data has reached “101”, the data transfer state information is displayed every time 10 pieces of data are transferred, and then in the further stage, when the number of transferred data has reached “201”, the data transfer state information is displayed every time 20 pieces of data are transferred. When a small number of data is transferred, it is more user-friendly to allow the user to see the state in which the data is transferred one piece by one piece. Also, when a small number of data is transferred, it does not take much time to display the number of data having been transferred so far each time one piece of data is transferred. Accordingly, this will not frustrate the user waiting for the data transfer to end. This function is achieved by holding a threshold value for used in changing the unit of transferred data in which the data transfer state information is displayed. For example, in the case of the above-described example, the mobile telephone only needs to have threshold values “100” and “200”, and a logic that the display of the number of data transferred is updated each time 10 pieces of data are transferred after the number of transferred data has reached “100”, and the display of the number of transferred data is updated each time 20 pieces of data are transferred after the number of transferred data has reached “200”.

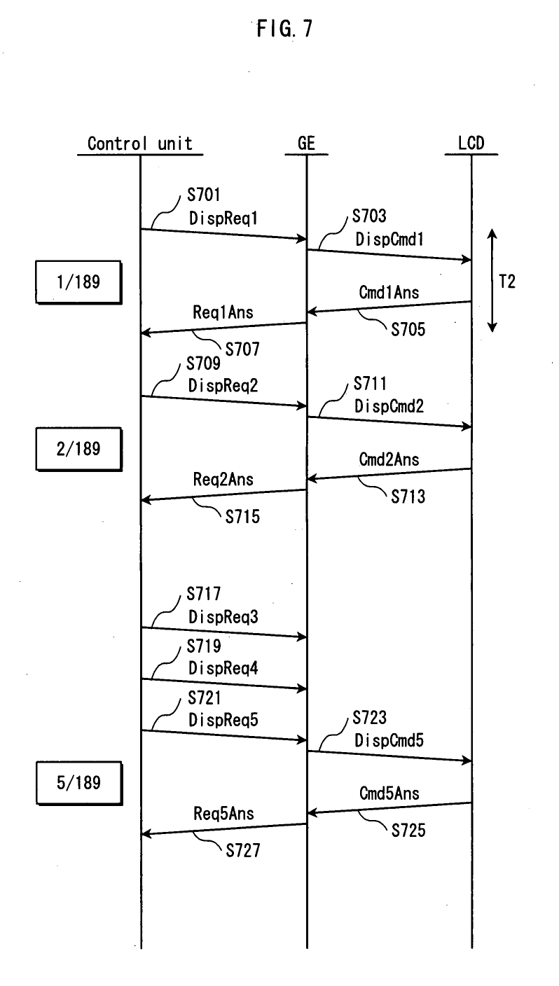

(6) Here, an explanation will be given as to what would happen if the data transfer was not synchronized with the data transfer state, for the sake of comparison, as it was merely briefly explained in the above-described embodiment. FIG. 7 is a sequence diagram showing a sequence of displays of transfer state during execution of a data transfer, when such synchronization is not taken.

FIG. 7 shows how the control unit, GE, and LCD operate when displaying information of transferred data during a data transfer.

First, the control unit writes data one by one in order from the storage unit to the memory card via the external memory attaching unit. The control unit outputs, to the GE, a display request DispReq1 requesting to display information indicating that a transfer of one piece of data has been completed (step S701).

Upon receiving the display request DispReq1, the GE generates pixel data of an image to be displayed, and outputs a display command DispCmd1 for causing the LCD to display the image using the generated pixel data (step S703). After this, the GE receives, from the LCD, a display completion command indicating that the LCD has completed the display.

It should be noted here that the data transfer continues to be executed by the control unit after the display request DispReq1 is output. After the transfer of the second piece is completed, the control unit outputs, to the GE, a display request DispReq2 requesting to display information indicating that a transfer of two pieces of data have been completed (step S709). Based on the display request DispReq2, steps S711, S713, and S715 are performed, and information indicating that a transfer of two pieces of data have been completed is displayed. In such a normal state, the number of transferred data is displayed in correspondence with the display request.

However, there may be a case where, for example, display requests DispReq3, DispReq4, and DispReq5 are continuously output as shown in steps S717, S719, and S721, when the GE is in a busy state, performing the process of displaying another image. In this case, the earlier display requests DispReq3 and DispReq4 may not be processed.

When this happens, only the lastly output DispReq5 is accepted, and the GE outputs DispCmd5 to the LCD. In response to this, the LCD displays “ 5/189” as the number of transferred data (steps S721, S723, S725, S727).

That is to say, display of “ 3/189” and “ 4/189” is omitted, although the information should be displayed continuously for each piece of data. An unexpected operation may cause another bug to occur in the machine. Therefore, unexpected operations should be avoided. This problem can be prevented by the structure of the present invention in which the data transfer is suspended when the number of transferred data is to be displayed.

The sign “T2” shown in FIG. 7 indicates a time period required for displaying the information. It is natural that the time period T2 is shorter than time period T1 shown in FIG. 5 since it does not include a time period for the wait process. Accordingly, the structure that takes the synchronization takes a longer time to perform the data transfer than the structure that does not take the synchronization. However, the present invention reduces the time required for the data transfer process since the structure thereof displays the information of the number of transferred data a reduced number of times.

(7) In the above-described embodiment, the number of data having been transferred is represented numerically as “ 20/189”, for example. However, not limited to this, the number of transferred data may be represented in other ways in so far as the user can recognize the number of transferred data. For example, a rectangular block may be used for this purpose, where, for example, a large block represents a unit of 10 pieces of data, and a small block represents a unit of 1 piece of data.

(8) In the above-described embodiment, a mobile telephone is used as an example of the information processing device. However, not limited to the mobile telephone, the present invention may be applied to any device that allows the number of transferred data to be displayed during a data transfer such that the number of times the information is displayed is smaller than the total number of data to be transferred in the data transfer. For example, when a PDA (Personal Digital Assistants) is connected to a flash memory, and a data transfer is executed between a memory of the PDA and the flash memory, the number of transferred data may be displayed during a data transfer such that the number of times the information is displayed is smaller than the total number of data to be transferred in the data transfer. As another example, when image data of pictures taken by a digital camera is transferred from the digital camera to a personal computer (PC), the number of transferred data may be displayed on the display screen of the digital camera every time 10 pieces of data, not one piece of data, are transferred.

(9) In the above-described embodiment, the number of transferred data is displayed when the transfer counter has “10” as the number of counts. However, not limited to this, the transfer counter may be omitted. That is to say, each time the total counter adds “1” to the numeral, the numeral indicating the counts of the total counter may be divided by “10”, and the display process may be performed when the quotient is an integer, based on the value of the quotient.

(10) In the above-described embodiment, the data is transferred in a unit of one piece of address data. However, not limited to this, any unit may be used to count the transferred data. For example, in the case where a plurality of sets of data, each of which is identified by a file name regardless of its amount of data, are transferred, one may be counted after all data related to the file name have been transferred. Alternatively, one may be counted each time a predetermined amount of data (for example, every 4096 kilobytes) is transferred as part of the total amount of data to be transferred.

(11) The present invention is a program for displaying the number of transferred data, the program being for use in an information processing device for updating display of the number of pieces of data having been transferred during execution of transferring a plurality of pieces of data, the program causing a computer loaded in the information processing device to execute a processing procedure for displaying the number of transferred data onto a display device, the processing procedure comprising the steps of:

performing a data transfer between a first storage medium provided in the information processing device and a second storage medium connected to the information processing device; and

causing the display device to display the number of pieces of data having been transferred such that the number of times the display is updated is smaller than the number of the plurality of pieces of data.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An information processing device for updating display of the number of pieces of data having been transferred during execution of transferring a plurality of pieces of data, the information processing device comprising:
a transfer unit operable to perform a data transfer between a first storage medium provided in the own device and a second storage medium connected to the own device; and
a display control unit operable to cause a display device to display the number of pieces of data having been transferred by the transfer unit such that the number of times the display is updated is smaller than the number of the plurality of pieces of data.

2. The information processing device of claim 1 further comprising a count unit operable to count the number of pieces of data having been transferred by the transfer unit, wherein
the display control unit causes the display device to display the number of pieces of data having been transferred, each time it counts a predetermined number of pieces of data having been transferred.

3. The information processing device of claim 2, wherein
the display control unit performs the control only when the number of pieces of data to be transferred is equal to or greater than another predetermined number.

4. The information processing device of claim 3 further comprising
a communication unit operable to perform a communication with another information processing device, wherein
the first storage medium stores address data for each communication destination, each piece of address data including data concerning said each communication destination, and
the number of pieces of data having been transferred is counted in a unit of a piece of address data.

5. The information processing device of claim 4, wherein
the transfer unit transfers the address data from the first storage medium to the second storage medium.

6. The information processing device of claim 1, wherein
the display device transmits information indicating a completion of a display to the display control unit, after displaying, under control of the display control unit, information indicating the number of pieces of data having been transferred and
the transfer unit suspends the data transfer after the display control unit causes the display device to display the number of pieces of data having been transferred, until the transfer unit receives the information indicating a completion of a display.

7. An information processing device for displaying information indicating the number of pieces of data having been transferred during execution of transferring a plurality of pieces of data, the information processing device comprising:
a transfer unit operable to perform a data transfer between a first storage medium provided in the own device and a second storage medium connected to the own device; and
a display control unit operable to cause a display device to display the number of pieces of data having been transferred such that the number of times the number of transferred data is displayed is smaller than the number of the plurality of pieces of data to be transferred.

8. A method of displaying the number of pieces of data having been transferred, for use in an information processing device for updating display of the number of pieces of data having been transferred during execution of transferring a plurality of pieces of data, the method comprising the steps of:
performing a data transfer between a first storage medium provided in the information processing device and a second storage medium connected to the information processing device; and
causing a display device to display the number of pieces of data having been transferred such that the number of times the display is updated is smaller than the number of the plurality of pieces of data.
